(19) United States
(12) Patent Application Publication
(10) Pub. No.: US 2026/0239133 A1
(43) Pub. Date: Aug. 13, 2026

(54) TECHNOLOGIES FOR HANDLING TIMING ADVANCES IN WIRELESS NETWORKS

(71) Applicant: Apple Inc., Cupertino, CA (US)

(72) Inventors: Naveen Kumar R. Palle Venkata, San Diego, CA (US); Yuqin Chen, Beijing (CN); Zhibin Wu, Los Altos, CA (US); Haijing Hu, Los Gatos, CA (US); Ping-Heng Kuo, London (GB); Fangli Xu, Beijing (CN); Peng Cheng, Beijing (CN); Ralf Rossbach, Munich (DE); Sethuraman Gurumoorthy, San Ramon, CA (US); Hong He, San Jose, CA (US); Qiming Li, Beijing (CN)

(73) Assignee: Apple Inc., Cupertino, CA (US)

(21) Appl. No.: 19/155,238

(22) PCT Filed: Feb. 10, 2023
(86) PCT No.: PCT/CN2023/075454

§ 371 Date: Aug. 8, 2025

(51) Int. Cl. H04W 36/04; H04L 5/00; H04W 56/00; H04W 72/231; H04W 74/0833; H04W 80/02

(52) U.S. Cl. CPC H04W 36/04; H04L 5/0051; H04W 56/0045; H04W 72/231; H04W 74/0833; H04W 80/02

(57) ABSTRACT

The present application relates to devices and components including apparatus, systems, and methods for handling timing advances in wireless networks.

### TECHNICAL FIELD

This application relates generally to communication networks and, in particular, to technologies for handling timing advances in wireless networks.

### BACKGROUND

Cellular communications can be defined in various standards to enable communications between a user equipment and a cellular network. For example, Third Generation Partnership Project (3GPP) provides Technical Specifications (TSs) that aim to improve upon data transmission speed, reliability, availability, and more. Aspects of these standards include provision and use of timing advances to enable coordination and proper reception of uplink communications from a user equipment to a network.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates the network environment in accordance with some embodiments.

FIG. 4 illustrates the network environment in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.” The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

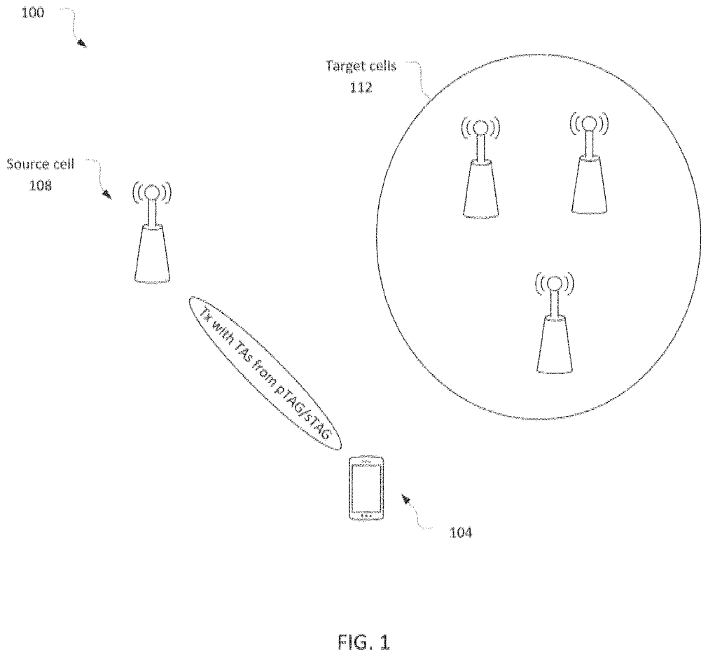

FIG. 1 illustrates a network environment 100 in accordance with some embodiments. The network environment 100 may include a UE 104 coupled with a source serving cell of source cell(s) 108 of a radio access network (RAN). The source cell(s) 108 may be provided by one or more base stations that provide an air interface compatible with 3GPP technical specifications, such as those that define Fifth Generation (5G) NR or later system standards.

In some embodiments, the source cell(s) 108 may be provided by a number of geographically dispersed nodes, e.g., transmit-receive points (TRPs). To effectively communicate with these TRPs, the UE 104 may be configured with different uplink timing advances (TAs). In general, the UE 104 may have a TA for each location. Each location may include one TRP or a plurality of co-located TRPs.

In some embodiments, the source cell(s) 108 may include a primary serving cell (PCell) and one or more secondary serving cells (SCells). The serving cells that include the same uplink TAs may be part of a TA group (TAG). If a TAG includes a PCell, the TAG may be referred to as a primary TAG (pTAG). If the TAG includes only SCells, the TAG may be referred to as a secondary TAG (sTAG). Methods, procedures, and variables for handling TAs for the pTAGs and sTAGs at a media access control (MAC) layer are provided by 3GPP TS 38.321 v17.3.0 (2023 Jan. 13).

In addition to the source cell(s) 108, the network environment 100 may include one or more target cells 112. In some embodiments, the target cells 112 may be candidate cells that are targets of a layer 2 triggered mobility (LTM) cell switch. An LTM cell switch may occur when the network provides an LTM cell switch command to the UE 104. The LTM cell switch command may be an L2 command (e.g., a MAC control element (CE)) provided to the UE 104. The network may determine whether an LTM cell switch is desired based on lower-layer measurements (e.g., measurements at layer 1 (L1) or L2) reported by the UE 104. In LTM, the UE 104 may perform a random access channel (RACH) operation on the target cell before the LTM cell switch command is received from the source cell(s) 108. This may allow the UE 104 to obtain a TA value of a target cell in time to reduce latency of the LTM cell switch.

In other embodiments, the target cells 112 may be used in a multi-TRP (mTRP) operation in which concurrent connections are maintained by the UE 104 with both the source cell(s) 108 and a target cell. In some instances, the concurrency of the connections may be relatively short to facilitate, e.g., a make-before-break handover.

In legacy mTRP scenarios, only one TA is supported. In other words, a UE's UL transmission toward mTRPs would need to be configured within the same TAG. This may inhibit LTM cell switches and mTRP operation in general.

Embodiments of the present disclosure describe support for a plurality of TAs to facilitate LTM cell switches and other mTRP operation. In particular, embodiments provide procedures to handle an additional TA value and associated management of that additional TA value in cases in which a TA/TAG is not considered as secondary, but primary. This may be the case when, e.g., the additional TA value is associated with a primary serving cell (e.g., an sPCell) after an LTM cell switch. Embodiments describe handling of associated timers, handling at expiration of original/new timers, and error handling at a source/target cell before an LTM cell switch.

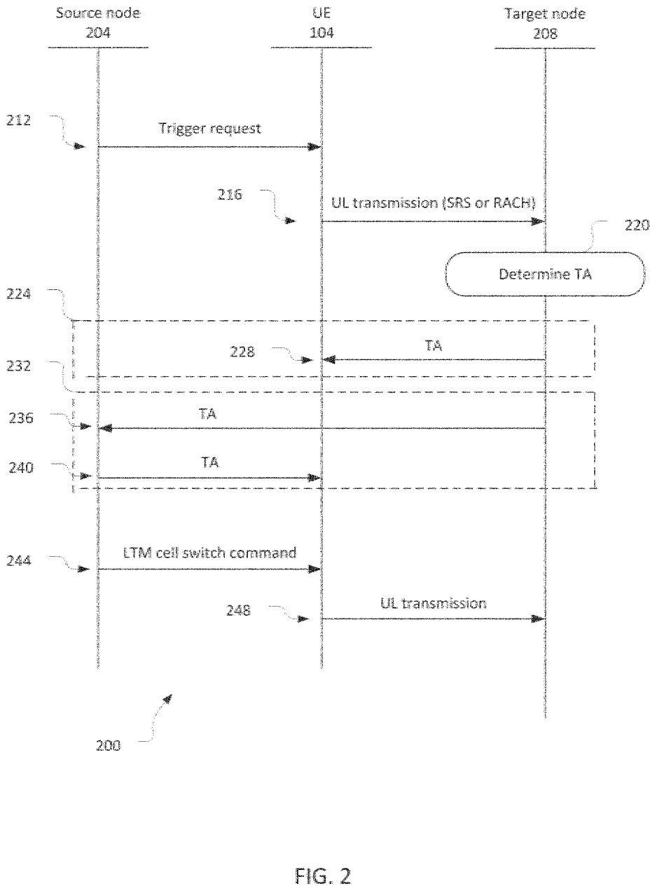

FIG. 2 is a signaling operation 200 in accordance with some embodiments. The signaling operation 200 may include signals/actions performed by a source node 204, UE 104, and a target node 208. The source node 204 may be a base station/TRP that provides a source serving cell, for example, a serving cell of source cell(s) 108. The target node may be a base station/TRP that provides a target cell of, e.g., target cells 112.

The signaling operation 200 may include, at 212, the source node sending a trigger request to the UE 104. The trigger request may include an index of a configuration for a target cell/node. While not specifically shown in the signaling operation 200, the network (e.g., the source node 204) may provide the UE 104 with configurations for each of a plurality of target cells/nodes. The trigger request may request the UE 104 to obtain a TA associated with the indicated target cell/node.

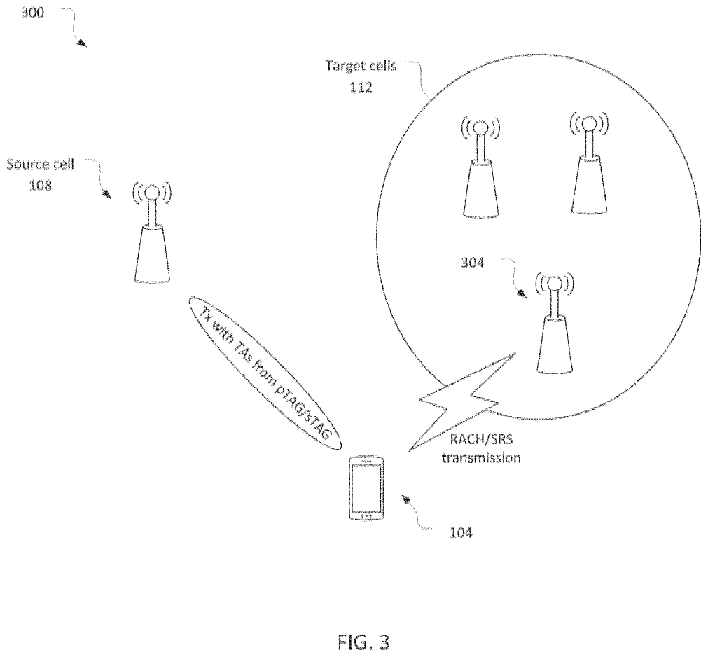

The signaling operation 200 may further include, at 216, the UE 104 sending an uplink transmission to the target node 208. The uplink transmission may serve as a basis for the target node 208 determining a TA value the UE 104 should use in UL communications toward the target cell. In some embodiments, the uplink transmission may be a RACH transmission. For example, the UE 104 may send a message 1 (Msg1) transmission that includes a random access preamble in a time-domain instance provided by the source node 204. In some embodiments, the UE 104 may send a sounding reference signal (SRS). The SRS may be similar to the RA preamble from the perspective of a physical layer (PHY). FIG. 3 is the network environment 100 with the UE 104 transmitting an uplink transmission (e.g., a RACH/SRS transmission) toward target LTM cell 304 to obtain a TA value in accordance with some embodiments. The target LTM cell 304 may be provided by the target node 208.

At 220, the target node 208 may determine a TA value based on the UL transmission. The TA value may be determined based on RACH, SRS, or in another manner that may be specific to a network implementation. For example, a network providing a small cell may provide the same initial TA value to all UEs and this value may later fine-tuned in subsequent transmit/receive transactions. Once determined, the TA value may be provided to the UE 104 in accordance with one or more options. In option 224, the target node 208 may provide the TA value directly to the UE 104 at 228. This may be in, e.g., a random access response (Msg2). In this case, the UE 104 may monitor a common channel for the random access response and determine whether the random-access response is for the UE 104 or another UE. In option 232, the target node 208 may send the TA value to the source node 204 at 236 and the source node 204 may provide the TA value to the UE 104 at 240.

The TA value may be provided to the UE 104, at 228 or 240, in a MAC CE or in downlink control information (DCI) transmitted in a physical downlink control channel (PDCCH). The message conveying the TA value may include one or more fields to provide the TA value or an identifier (ID) that may be used to identify the target cell associated with the TA.

The TA value may be an absolute value (e.g., similar to an absolute timing advance command MAC CE) or a relative value. If the TA value is a relative value, it may be relative to: the current source serving cell; the candidate target cell (e.g., the DL reference signal determined by synchronizing with the target cell); a pTAG; or an sTAG.

The ID that may be used to identify the target cell may be defined based on one or more of the following options. In a first option, the ID may be a physical cell identity (PCI) of the target cell where the UE 104 performed the RACH/SRS. In a second option, the ID can be a configuration index that links the ID to the target LTM cell with which the UE 104 is earlier configured. In a third option, the ID can be a separate TAG ID for which the UE 104 was earlier asked to perform the RACH/SRS.

Upon receiving a TA value, the UE 104 may use the ID associated with the TA value to determine whether the TA value is for the target LTM cell 304. If the TA is for the target LTM cell 304, the UE 104 may store the TA value for the associated index. For example, the TA value may be stored with the configuration information associated with the target LTM cell 304.

In some embodiments, the UE 104 may be provided with a plurality of independent TA groups. Each TA group may be associated with multiple cells, with each cell having a TA. The UE 104 may send UL transmissions and receive TAs for each of the TA groups. The number of TA groups for which the UE 104 is capable of obtaining and saving associated TA values may be based on a UE capability. This capability may be signaled to the source serving cell so the network does not trigger the uplink transmissions on more target LTM cells than the UE 104 is capable of handling.

In some embodiments, the UE 104 may have a TA timer associated with each TA group. The TA timer may be started/restarted when a TA associated with the TA group is received. For example, if a TA group of a first target LTM cell is configured with a first TA timer, the first TA timer may be started/restarted when a TA, associated with an ID of the first target LTM cell (or TA group), is received. The TA timer expiration may invalidate the associated TA. In some embodiments, the new TA timer may not affect the legacy timing advance timer (timingAdvanceTimer) associated with the current serving cell.

In some embodiments, rather than relying on a TA timer, the validity of the TA values obtained for LTM operation toward a non-serving cell may be controlled by the network. For example, a TA value provided by the network may simply be considered valid and not expired. In these cases, the network may be responsible for triggering a TA update if the current TA is no longer valid.

If the UE 104 determines a received TA value is not for a target LTM cell, based on the ID, the UE 104 may follow existing procedures for processing a TA command as part of TA reception as defined in 3GPP TS 38.321.

The signaling operation 200 may further include, at 244, the source node 204 sending an LTM cell switch command to the UE 104. The LTM cell switch command may be an L2 message based on lower-layer measurements provided to the network.

The signaling operation 200 may further include, at 248, the UE 104 performing an uplink transmission with the target node 208. This uplink transmission may be part of, or the result of, an LTM cell switch. In some embodiments, the UE 104 may determine whether the TA value provided at 228 or 240 is still valid. If so, the UE 104 may use the TA value. If not, the UE 104 may need to acquire a new TA value. This may be done by, for example, performing a RACH procedure.

As briefly mentioned above, in some embodiments, the validity of the TA value may be based on an associated TA timer. For example, the UE 104 may determine whether it has a valid (e.g., non-expired) TA timer associated with an ID of the target LTM cell at the time of receiving the LTM cell switch command at 244. If the TA timer is valid, the UE 104 may determine the TA value is also valid. Thus, the UE 104 may apply the TA value for the uplink transmission on the LTM target cell.

In embodiments in which there is no TA timer associated with the target LTM cells (e.g., only legacy TA timer associated with the serving cell is present), one or more of the following three options may be used.

In a first option, if the legacy TA timer is running, the UE 104 may consider the TA value associated with the target LTM cell valid. Thus, the UE 104 may apply the TA value for the uplink transmission on the LTM target cell. In this option, the legacy TA timer may be the pTAG timer or sTAG timer. The network may provide the UE 104 with an explicit indication of which timer to use. Alternatively, the timer to use may be predefined by, for example, a 3GPP TS. For example, the UE 104 may always apply the pTAG timer as the legacy timer to validate the TA value associated with a target LTM cell.

In a second option, the UE 104 may always apply the provided TA value to the uplink transmission to the target LTM cell. In this option, no RACH procedure would be performed after receiving the LTM cell switch command at 244, and no consideration would be given to the legacy TA timer with respect to the TA value associated with the target LTM cell.

In a third option, the LTM cell switch command transmitted at 244 may include an indicator field to indicate one or more of the following procedures for uplink timing advance. In a first procedure, the UE 104 may use a current TA value associated with the target LTM cell. In a second procedure, the LTM cell switch command may include an updated TA value that the UE 104 is to use for uplink transmissions to the target LTM cell. In a third procedure, the indicator field may include a value to trigger a contention-free random-access (CFRA) or contention-based random access (CBRA) procedure to obtain an updated TA value during LTM operation. The UE 104 may perform a CFRA procedure by using a dedicated random access preamble provided to the UE 104 by the network. The UE 104 may perform a CBRA procedure by randomly selecting a preamble from a pool of preambles shared with other UEs.

Expiration of a legacy TA timer of the current serving cell may be handled in accordance with one or more of the following options.

In a first option, the UE 104 may not invalidate any TA timers of target LTM cells, but may not consider any new MAC CE (or DCI) that have new TA values that are received after expiration of the legacy TA timer. Consider, for example, a first TA timer that is running based on receipt of a first TA value being received for a first target LTM cell. If the UE 104 receives an updated TA value for the first target LTM cell after a legacy TA timer has expired, the UE 104 may not consider the updated TA value. In this case, the UE 104 may not restart the first TA timer or update the first TA value based on receiving the updated TA value.

In a second option, operation of the UE 104 may not be affected by the expiration of the legacy TA timer. The UE 104 may continue to operate/manage LTM-specific TA values/timers and consider them valid independent from the legacy TA timer. If the UE 104 receives a new downlink MAC CE/DCI with updates to TA values for target LTM cells, the UE 104 may consider them as valid and apply them (and start/restart any associated timers). The UE 104 may do this regardless of whether the legacy TA timer is running or expired.

In a third option, upon determining that a legacy TA timer has expired, the UE 104 may invalidate all TA values of the target LTM cells and stop associated timers.

In the event the UE 104 determines that a TA timer associated with a first target LTM cell has expired, the UE 104 may perform one or more of the following three options.

In a first option, the UE 104 may invalidate the TA value for the first target LTM cell. If there is an LTM cell switch to this target LTM cell, the UE 104 may initiate a RACH procedure (e.g., a CBRA procedure) for the target LTM cell to obtain an updated TA value. The UE may perform the RACH procedure even if a RACH-less option was configured. With respect to the first option, the legacy TA timer and operation of the transmit/TA management of the legacy serving cell may not be changed.

In a second option, in addition to invalidating the TA value for the first LTM cell as described above with respect to the first option, the UE 104 would invalidate the context of all other target LTM cells with regard to their TA values/timers.

In a third option, in addition to invalidating the context of all other target LTM cells, the UE 104 would consider the legacy TA timer of the serving cell as expired.

Using the expiration of a TA timer associated with the first target LTM cell to invalidate TA values/timers associated with other target LTM cells and even the serving cell (as described in the second and third options) may be a result of the network taking responsibility for managing the TA values of all the cells. To prevent invalidation of TA values, the network may timely update the TA values to restart the associated TA timers. In the event that the updates are not timely, the TA values may be invalidated to ensure that outdated TA values are not used.

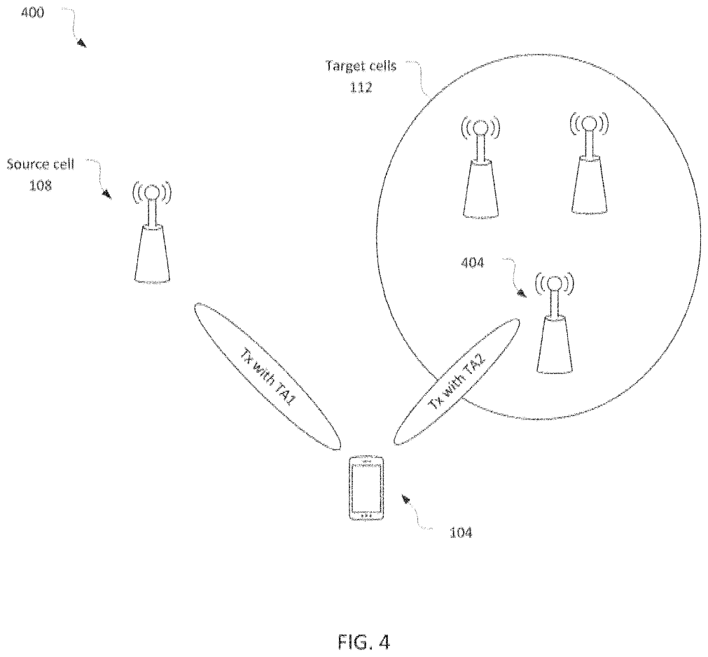

FIG. 4 illustrates the network environment 100 in which the UE 104 is engaged in an mTRP operation in accordance with some embodiments. In this embodiment, the UE 104 may be configured to send uplink transmissions to a first TRP of the source cell(s) 108 with a first TA (TA1) and may be configured to send uplink transmission to a second TRP of a target cell 404 of the target cells 112 with a second TA (TA2). The target cell 112 may or may not be a target LTM cell. In some embodiments, the UE 104 may be configured to maintain concurrent uplink communications with both the first TRP and the second TRP for a period of time. The period of time may be in the context of a transition, for example, a handover or switch. In some instances, the UE 104 may be configured for communications with the second TRP concurrently with the first TRP in a make-before-break handover to reduce mobility interruption. In some instances, the UE 104 and first and second TRPs may perform a multi-DCI mTRP operation in which the UL/DL transmissions to the first/second TRPs are scheduled using DCIs transmitted by respective TRPs.

The difference between the timing of the uplink transmissions to the first TRP and uplink transmissions to the second TRP, which may be referred to as a transmit-timing difference (TTD), may be limited by a predetermined threshold. For example, for both intra-cell and inter-cell mTRP operation in frequency range 1 (FR1), the maximum TTD may be CP +MI microseconds, where CP is a length of a cyclic prefix and M1 is a first offset for FR1. For a UE capable of supporting a scenario in which a round trip delay (RTD) is greater than the cyclic prefix in FR1, the maximum TTD may be 34.6 microseconds. For both intra-cell and inter-cell multi-DCI mTRP operation in frequency range 2 (FR2), the maximum TTD may be CP+M2 microseconds, where CP is length of a cyclic prefix and M2 is a second offset for FR2. For a UE capable of supporting a scenario in which an RTD is greater than the cyclic prefix in FR2, the maximum TTD may be 8.5 microseconds.

Some embodiments describe TA handling in the event the TTD exceeds a maximum TTD. The TA handling may be in accordance with one or more of the following two options.

In a first option, the UE 104 may suspend transmission on one of the TRPs (for example, the first TRP or the second TRP). The TA value linked to the TRP for which transmissions are suspended may be considered invalid. The TA timer associated with the suspended TRP may be stopped. This option may be based on an assumption that the TA timer is restarted when a new TA value is received. A new TA value may be received when a reconfiguration of the communication link is performed by the network.

In a second option, the TTD exceeding the predetermined threshold may not be associated with a change to the handling of the TA timers. For example, the UE 104 may continue communications with TRP 1 using TA1 if the associated TA timer is running and may also continue communications with TRP 2 using TA2 if the associated TA timer is running.

Many of the above embodiments describe TA handling when the network provides a new TA value to the UE 104. However, in some instances, a change in TA association for LTM or TRP may be done with a change in a transmission configuration indicator (TCI) state. For example, the UE 104 may be given an updated TCI state with respect to a target cell. While the TCI state may refer to a downlink reference signal, this may also result in changes to uplink transmission characteristics. For example, the UE 104 may measure the downlink reference signal indicated by the TCI state to obtain channel estimates that are then applied for uplink transmissions. Thus, a TCI state change that changes the downlink reference signal used as a basis for determining channel estimates for the uplink transmission may change the TA association for a particular target cell.

In the event a TA association change for a target cell is done with a TCI state change, the UE 104 may consider the TA association change as an assignment of a new TA value of the current target LTM cell/mTRP. The UE 104 may apply the new TA value in uplink communications in the target cell. The validity of the TA value may be based on a TA timer associated with the target cell as discussed elsewhere herein. Additionally/alternatively, the validity of the TA value may be done without a TA timer specifically configured for the target cell similar to that discussed elsewhere herein. In these embodiments, the legacy TA timer may not be changed based on the TA association change.

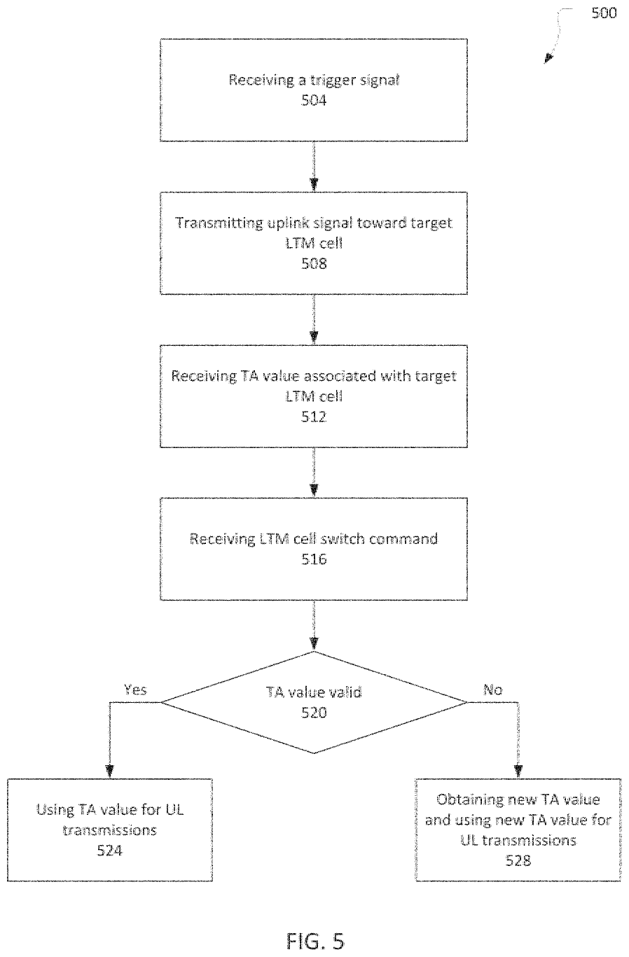

FIG. 5 illustrates an operational flow/algorithmic structure 500 for TA handling in accordance with some embodiments. The operational flow/algorithmic structure 500 may be implemented by a UE such as, for example, UE 104 or 900 or components therein, for example, processing circuitry 904.

The operational flow/algorithmic structure 500 may include, at 504, receiving a trigger signal. The trigger signal may be received from a serving cell and may instruct the UE to obtain a TA value associated with a target LTM cell.

The operational flow/algorithmic structure 500 may further include, at 508, transmitting an uplink signal toward the target LTM cell. The uplink signal may be a RACH signal (e.g., a msg1 transmission) or an SRS.

The operational flow/algorithmic structure 500 may further include, at 512, receiving a TA value associated with the target LTM cell. The UE may receive the TA value in a MAC CE or DCI from the source serving cell or the target LTM cell. The TA value may be transmitted with an identifier of the target LTM cell, a configuration index associated with the target LTM cell, or a TA group. The TA value may be: an absolute value; relative to timing of the serving cell; relative to timing of the target LTM cell; relative to timing of a pTAG; or relative to timing of an sTAG.

Upon receiving the TA value, the UE may store the TA value with a configuration associated with the target LTM cell. In some embodiments, the UE may be capable of storing/maintaining TA values for a number of TA groups. In these embodiments, the UE may provide an indication to a base station of the number of TA groups for which the UE is capable of maintaining TA information. If the TA value is associated with a TA timer, the UE may restart the TA timer upon receiving the TA value.

The operational flow/algorithmic structure 500 may further include, at 516, receiving an LTM cell switch command. The LTM cell switch command may be received from the source cell and may instruct the UE to perform an LTM cell switch to the target LTM cell.

The operational flow/algorithmic structure 500 may further include, at 520, determining whether the TA value is valid. In some embodiments, the TA value may be considered valid until receiving an updated TA value. In other embodiments, the validity of the TA value may be determined based on whether an associated TA timer is running. The TA timer may be associated specifically with the target LTM cell, may be associated with another target LTM cell, or may be associated with the source cell. If the UE determines the TA value is valid, the operational flow/algorithmic structure may proceed to using the TA value for uplink transmissions toward the target LTM cell at 524.

If the UE determines the TA value is not valid (e.g., an associated TA timer has expired), the operational flow/algorithmic structure may proceed to obtaining a new TA value in using the new TA value for uplink transmissions. In some embodiments, the new TA value may be obtained by performing a RACH operation with the target LTM cell.

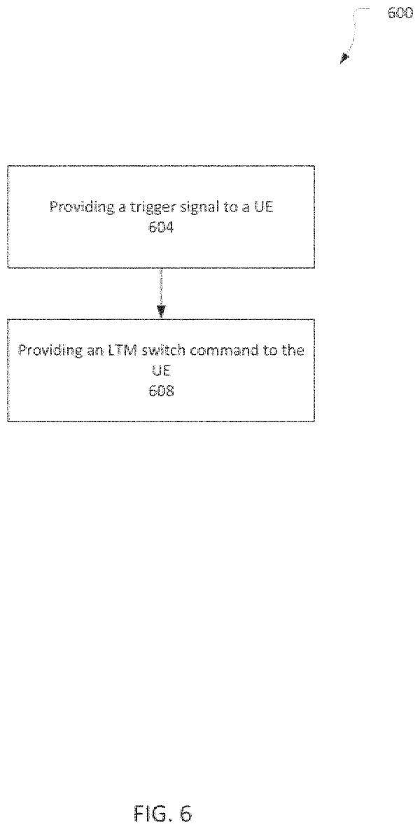

FIG. 6 illustrates an operational flow/algorithmic structure 600 for LTM cell switch operation in accordance with some embodiments. The operational flow/algorithmic structure 600 may be implemented by a base station or TRP such as, for example, source node 204, network node 1000 or components therein, for example, processing circuitry 1004. The base station or TRP may provide a serving cell of source cell(s) 108.

The operational flow/algorithmic structure 600 may include, at 604, providing a trigger signal to a UE. The trigger signal may indicate that the UE is to obtain a TA value with respect to a target LTM cell.

In some embodiments, the TA value may be provided to the UE directly from the target LTM cell. In other embodiments, the target LTM cell may provide the TA value to the base station, which may then provide the TA value to the UE.

The operational flow/algorithmic structure 600 may further include, at 608, providing an LTM cell switch command to the UE. This LTM cell switch command may trigger an LTM cell switch to the target LTM cell. In some embodiments, the LTM cell switch command may include the TA value and, potentially, an associated TA timer.

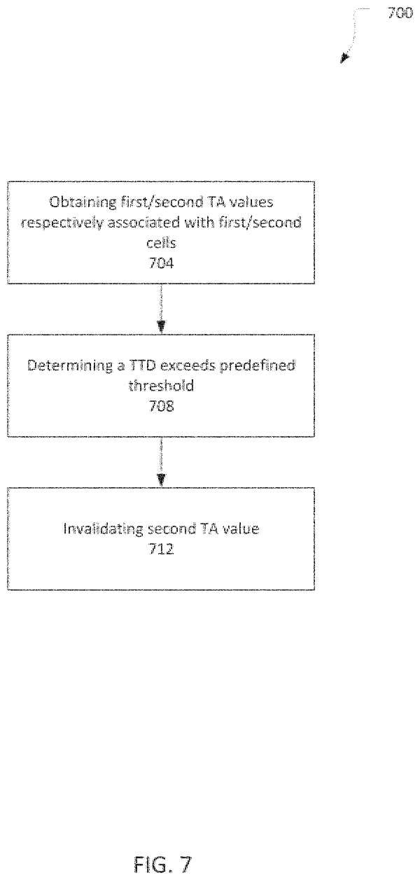

FIG. 7 is an operational flow/algorithmic structure 700 in accordance with some embodiments. The operational flow/algorithmic structure 700 may be implemented by a UE, for example, UE 104 or UE 900, or components therein, for example, processors 904.

The operational flow/algorithmic structure 700 may include, at 704, obtaining first and second TA values that respectively correspond to first and second cells. In some embodiments, the first and second cells may include a source cell and a target LTM cell. In some embodiments, the first and second cells may be respectively provided by first and second TRPs in a mTRP operation.

In some embodiments, TA timers may be associated with each of the first and second cells. These TA timers may be started/restarted upon receiving the first/second TA values.

The operational flow/algorithmic structure 700 may further include, at 708, determining a TTD exceeds a predefined threshold. The threshold may be statically defined by, for example, a 3GPP TS or may be dynamically configured by the network. In some embodiments, the threshold may be based on whether the UE is operating in FR1 or FR2.

The operational flow/algorithmic structure 700 may further include, at 712, invalidating the second TA value. In the event a TA timer is associated with the second TA value, the TA timer may also be stopped.

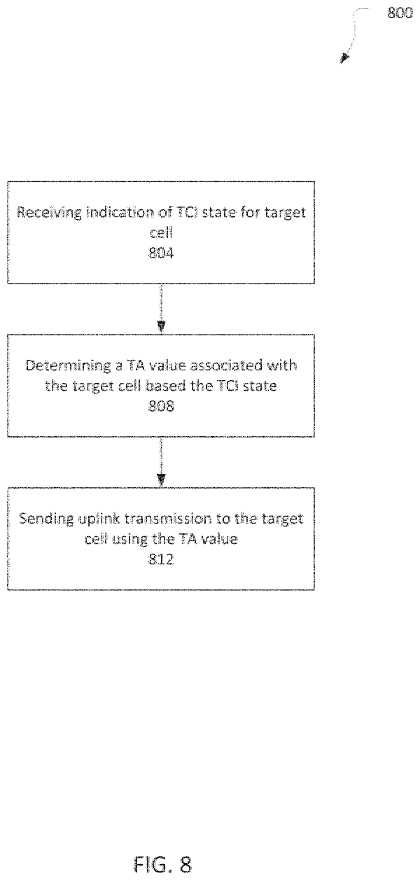

FIG. 8 is an operational flow/algorithmic structure 800 for TA handling in accordance with some embodiments. The operational flow/algorithmic structure 600 may be implemented by a UE such as, for example, UE 104 or 900 or components therein, for example, processing circuitry 904.

The operational flow/algorithmic structure 800 may include, at 804, receiving an indication of a TCI state for a target cell. The indication may be transmitted in DCI that updates a TCI state in the target cell. The target cell may be a target LTM cell or provided by a TRP as part of an mTRP operation.

The operational flow/algorithmic structure 800 may further include, at 808, determining a TA value associated with the target cell based on the TCI state. In some embodiments, the TA value may be associated with the TA timer that is started/restarted when the indication of the TCI state is received.

The operational flow/algorithmic structure 800 may further include, at 812, sending an uplink transmission to the target cell using the TA value. In some embodiments, the uplink transmission may be the result of an LTM cell switch. For example, the UE may perform the uplink transmission after receiving the LTM cell switch command. In some instances, the UE may determine whether the TA value is valid before using it for the uplink transmission. This may be based on an TA timer associated with the TA value. Alternatively, the TA value may be assumed to be valid unless an updated TA value is received. If the TA value is not valid after receiving the LTM cell switch command, the UE may perform a RACH on the target cell to obtain an updated TA value.

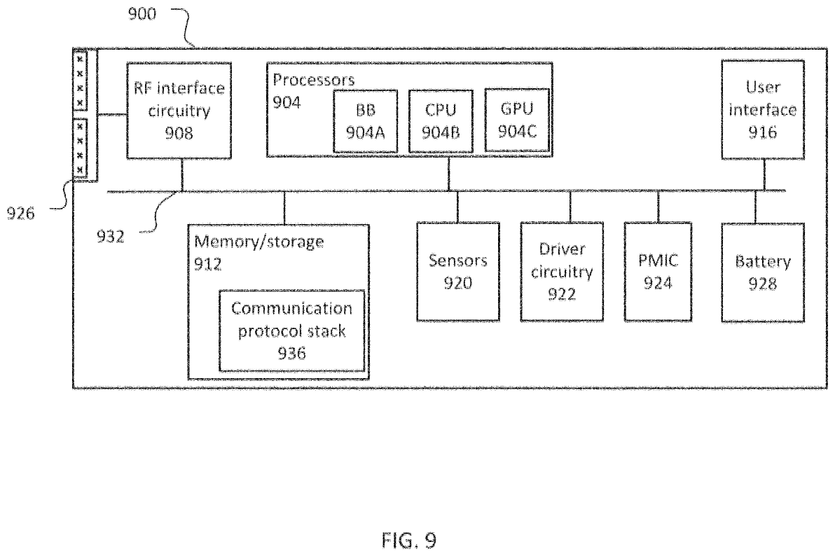

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various TA handling/management operations described herein. For example, the processors 904 may cause the UE to perform the operational flow/algorithmic structure 500, 700, or 800 or any other method or process describe herein. In some embodiments, some or all of these TA handling/management operations may be performed by a MAC layer of the UE 900.

The memory/storage 912 include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 926.

In various embodiments, the RF interface circuitry 908 may be configured to transmit/receive signals in a manner compatible with NR access technologies.

The antenna structure 926 may include antenna elements to convert electrical signals into radio waves to travel through the air and to convert received radio waves into electrical signals. The antenna elements may be arranged into one or more antenna panels. The antenna structure 926 may have antenna panels that are omnidirectional, directional, or a combination thereof to enable beamforming and multiple input, multiple output communications. The antenna structure 926 may include microstrip antennas, printed antennas fabricated on the surface of one or more printed circuit boards, patch antennas, or phased array antennas. The antenna structure 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within, or connected to, the UE 900. For example, the driver circuitry 922 may include circuitry to facilitate coupling of a UICC (for example, UICC 98) to the UE 900. For additional examples, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900 including DRX as discussed herein.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

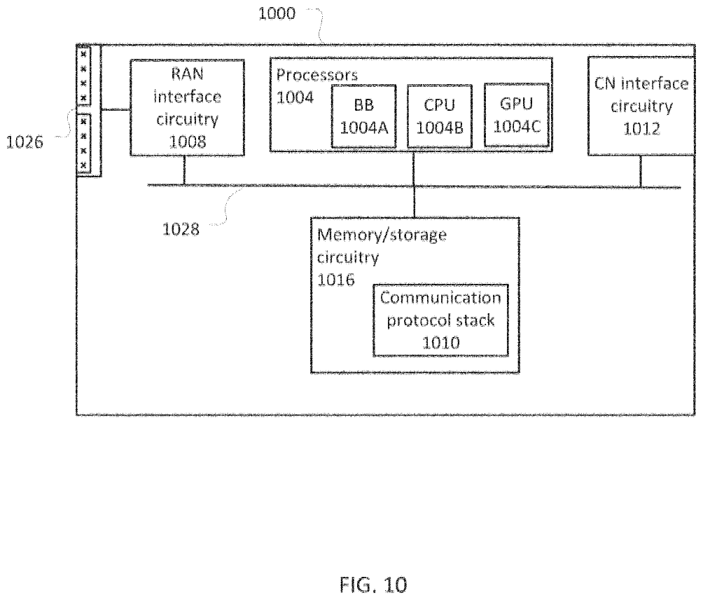

FIG. 10 illustrates a network node 1000 in accordance with some embodiments. The network node 1000 may be similar to and substantially interchangeable with a base station or TRP providing one or more serving cell of the source cell(s) 108 or target cells 112.

The network node 1000 may include processors 1004, RF interface circuitry 1008 (if implemented as an access node), core network (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage 1016 (including communication protocol stack 1010), antenna structure 1026, and interconnects 1028 may be similar to like-named elements shown and described with respect to FIG. 9.

The memory/storage 1016 may include one or more non-transitory, computer-readable media that includes instructions (for example, communication protocol stack 1010) that may be executed by one or more of the processors 1004 to cause the network node 1000 to perform various TA handling/management operations described herein. For example, the processors 1004 may cause the network node 1000 to perform the operational flow/algorithmic structure 600 or any other method or process describe herein.

The CN interface circuitry 1012 may provide connectivity to a core network, for example, a 5th Generation Core network (5GC) using a 5GC-compatible network interface protocol such as carrier Ethernet protocols, or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.
Example 1 includes a method of operating a user equipment (UE), the method comprising: receiving a trigger signal from a source cell; transmitting an uplink signal toward a target layer 2 triggered mobility (LTM) cell based on the trigger signal; receiving a timing advance (TA) value associated with the target LTM cell; receiving an LTM cell switch command; determining whether the TA value is valid; and performing an LTM cell switch based on receiving the LTM cell switch command and determining whether the TA value is valid.
Example 2 includes the method of example 1 or some other example herein, wherein determining whether TA value is valid comprises determining the TA value is valid and the method further comprises: performing the LTM cell switch by sending an uplink transmission to the target LTM cell using the TA value.
Example 3 includes the method of example 1 or some other example herein, wherein the TA value is a first TA value, determining whether the first TA value is valid comprises determining the first TA value is not valid, and the method further comprises: obtaining a second TA value; and performing the LTM cell switch using the second TA value.
Example 4 includes a method of example 1 or some other example herein, wherein the uplink signal is a random-access channel (RACH) transmission or a sounding reference signal (SRS) transmission.
Example 5 includes the method of example 1 or some other example herein, further comprising: receiving, from the source cell or the target LTM cell, the TA value in a media access control (MAC) control element (CE) or downlink control information (DCI).
Example 6 includes the method of example 5 or some other example herein, wherein the MAC CE or DCI includes an identifier associated with the target LTM cell, the identifier being a physical cell identity (PCI) of the target LTM cell, a configuration index associated with the target LTM cell, or a TA group identifier.
Example 7 includes the method of example 1 or some other example herein, wherein the TA value is a first TA value is: an absolute value; relative to timing of the source cell; relative to timing of the target LTM cell; relative to timing of a primary timing advance group; or relative to timing of a secondary timing advance group.
Example 8 includes the method of example 1 or some other example herein, further comprising: receiving a configuration associated with the target LTM cell; and storing the TA value with the configuration.
Example 9 includes the method of example 1 or some other example herein, further comprising: providing, to a base station, an indication of a number of TA groups for which the UE is capable of maintaining TA information.
Example 10 includes the method of example 1 or some other example herein, further comprising: determining, based on receiving the LTM cell switch command, whether a timer is expired; and determining whether the TA value is valid based on said determining whether the timer is expired.
Example 11 includes a method of example 10 or some other example herein, wherein the timer is associated with the target LTM cell and the method further comprises: starting or restarting the timer based on receiving the TA value.
Example 12 includes the method of example 11 or some other example herein, further comprising: determining a TA timer associated with the source cell is expired; and invalidating the TA value and stopping the timer associated with the target LTM cell based on determining the TA timer associated with the source cell is expired.
Example 13 includes a method of example 11 or some other example herein, wherein determining whether the timer is expired comprises determining the timer is expired and the method further comprises: invalidating the TA value and performing a random access channel (RACH) procedure as part of performing the LTM cell switch; invalidating the TA value, performing a random access channel (RACH) procedure as part of performing the LTM cell switch, and invalidating one or more additional TA values respectively associated with one or more additional target LTM cells; or invalidating the TA value, performing a random access channel (RACH) procedure as part of performing the LTM cell switch, invalidating one or more additional TA values respectively associated with one or more additional target LTM cells, and considering a TA timer associated with the source cell is expired.
Example 14 includes a method of example 10 or some other example herein, wherein the timer is associated with the source cell, a primary TA group, or a secondary TA group.
Example 15 includes the method of example 1 or some other example herein, wherein the TA value is a first TA value and the method further comprises: determining a TA timer associated with the source cell is expired; receiving a second TA value associated with the target LTM cell; and discarding the second TA value based on determining the TA timer associated with the source cell is expired.
Example 16 includes the method of example 1 or some other example herein, wherein the TA value is a first TA value and the LTM cell switch command includes an indication to use, for an uplink transmission to the target LTM cell: the first TA value; a second TA value that is in the LTM cell switch command; or a second TA value to be obtained through a random access channel (RACH) procedure.
Example 17 includes a method of operating a base station, the method comprising: providing, to a user equipment (UE), a trigger signal to trigger transmission of an uplink signal toward a target layer 2 triggered mobility (LTM) cell to acquire a timing advance (TA) value; and providing, to the UE an LTM cell switch command to trigger an LTM cell switch to the target LTM cell.
Example 18 includes the method of example 17 or some other example herein, further comprising: receiving the TA value from the LTM cell; and providing the TA value to the UE.
Example 19 includes the method of example 18 or some other example herein, wherein providing the TA value comprises providing the TA value in the LTM cell switch command.
Example 20 includes a method of operating a user equipment (UE), the method comprising: obtaining a first timing advance (TA) value associated with a first cell; obtaining a second TA value associated with a second cell; determining a transmit timing difference (TTD) based on the first and second TA values; determining the TTD exceeds a predefined threshold; and invalidating the second TA value based on determining the TTD exceeds the predefined threshold.
Example 21 includes the method of example 20 or some other example herein, further comprising: starting or restarting a timer associated with the second cell based on obtaining the second TA value; and stopping the timer based on determining the TTD exceeds the predefined threshold.
Example 22 includes the method of example 20 or some other example herein, wherein the first cell is a source cell and the second cell is a target cell.
Example 23 includes the method of example 22 or some other example herein, wherein the target cell is a layer 2 triggered mobility (LTM) cell.
Example 24 includes the method of example 20 or some other example herein, wherein the UE is configured for multi-transmit-receive point (TRP) operation.
Example 25 includes a method of operating a user equipment (UE), the method comprising: receiving an indication of a transmission configuration indicator (TCI) state for a target cell; determining a timing advance (TA) value associated with the target cell based on the TCI state; and sending an uplink transmission to the target cell using the TA value.
Example 26 includes a method of example 25 or some other example herein, further comprising: starting or restarting a timer based on receiving the indication of the TCI state; receiving a layer 2 triggered mobility (LTM) cell switch command; determining the timer is not expired based on receiving the LTM cell switch command; and sending the uplink transmission to the target cell using the TA value based on said determining the timer is not expired.
Example 27 includes the method of example 25 or some other example herein, wherein the UE is configured for multi-TRP operation.

Another example may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example include a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1-27. (canceled)

28. One or more non-transitory, computer-readable media having instructions that, when executed by one or more processors, cause processor circuitry to:
receive a trigger signal from a source cell;
transmit an uplink signal toward a target layer 2 triggered mobility (LTM) cell based on the trigger signal;
receive a timing advance (TA) value associated with the target LTM cell;
receive an LTM cell switch command;
determine whether the TA value is valid; and
perform an LTM cell switch based on receipt of the LTM cell switch command and determination of whether the TA value is valid.

29. The one or more non-transitory, computer-readable media of claim 28, wherein to determine whether the TA value is valid determine the TA value is valid and the instructions, when executed, further cause the processor circuitry to:
perform the LTM cell switch by sending an uplink transmission to the target LTM cell using the TA value.

30. The one or more non-transitory, computer-readable media of claim 28, wherein the TA value is a first TA value, to determine whether the first TA value is valid comprises determine the first TA value is not valid, and the instructions, when executed, further cause the processor circuitry to:
obtain a second TA value; and
perform the LTM cell switch using the second TA value.

31. The one or more non-transitory, computer-readable media of claim 28, wherein the uplink signal is a random-access channel (RACH) transmission or a sounding reference signal (SRS) transmission.

32. The one or more non-transitory, computer-readable media of claim 28, wherein instructions, when executed, further cause the processor circuitry to:
receive, from the source cell or the target LTM cell, the TA value in a media access control (MAC) control element (CE) or downlink control information (DCI),
wherein the MAC CE or DCI includes an identifier associated with the target LTM cell, the identifier being a physical cell identity (PCI) of the target LTM cell, a configuration index associated with the target LTM cell, or a TA group identifier.

33. The one or more non-transitory, computer-readable media of claim 28, wherein the TA value is a first TA value is: an absolute value; relative to timing of the source cell; relative to timing of the target LTM cell; relative to timing of a primary timing advance group; or relative to timing of a secondary timing advance group.

34. The one or more non-transitory, computer-readable media of claim 28, wherein instructions, when executed, further cause the processor circuitry to:
receive a configuration associated with the target LTM cell; and
store the TA value with the configuration.

35. The one or more non-transitory, computer-readable media of claim 28, wherein instructions, when executed, further cause the processor circuitry to:
generate, for transmission to a base station, an indication of a number of TA groups for which a user equipment is capable of maintaining TA information.

36. The one or more non-transitory, computer-readable media of claim 28, wherein instructions, when executed, further cause the processor circuitry to:
start or restart a timer that is associated with the target LTM cell based on receiving the TA value;
determine, based on receipt of the LTM cell switch command, whether the timer is expired; and
determine whether the TA value is valid based on determination of whether the timer is expired.

37. The one or more non-transitory, computer-readable media of claim 36, wherein instructions, when executed, further cause the processor circuitry to:
determine a TA timer associated with the source cell is expired; and
invalidate the TA value and stop the timer associated with the target LTM cell based on determination that the TA timer associated with the source cell is expired.

38. The one or more non-transitory, computer-readable media of claim 36, wherein to determine whether the timer is expired comprises determine the timer is expired and the instructions, when executed, further cause the processor circuitry to:
invalidate the TA value and performing a random access channel (RACH) procedure as part of performing the LTM cell switch;
invalidate the TA value, performing a random access channel (RACH) procedure as part of performing the LTM cell switch, and invalidate one or more additional TA values respectively associated with one or more additional target LTM cells; or
invalidate the TA value, performing a random access channel (RACH) procedure as part of performing the LTM cell switch, invalidate one or more additional TA values respectively associated with one or more additional target LTM cells, and consider a TA timer associated with the source cell is expired.

39. The one or more non-transitory, computer-readable media of claim 36, wherein the timer is associated with the source cell, a primary TA group, or a secondary TA group.

40. The one or more non-transitory, computer-readable media of claim 28, wherein the TA value is a first TA value and the instructions, when executed, further cause the processor circuitry to:
determine a TA timer associated with the source cell is expired;
receive a second TA value associated with the target LTM cell; and
discard the second TA value based on determination that the TA timer associated with the source cell is expired.

41. The one or more non-transitory, computer-readable media of claim 28, wherein the TA value is a first TA value and the LTM cell switch command includes an indication to use, for an uplink transmission to the target LTM cell: the first TA value; a second TA value that is in the LTM cell switch command; or a second TA value to be obtained through a random access channel (RACH) procedure.

42. A method of wireless communication, the method comprising:
generating a trigger signal to be transmitted to a user equipment (UE), the trigger signal to trigger transmission of an uplink signal toward a target layer 2 triggered mobility (LTM) cell to acquire a timing advance (TA) value; and
generating an LTM cell switch command to be transmitted to the UE, the LTM cell switch command to trigger an LTM cell switch to the target LTM cell.

43. The method of claim 42, further comprising:
receiving the TA value from the LTM cell; and
providing the TA value to the UE.

44. The method of claim 43, wherein providing the TA value comprises providing the TA value in the LTM cell switch command.

45. A method of wireless communication, the method comprising:
obtaining a first timing advance (TA) value associated with a first cell;
obtaining a second TA value associated with a second cell;
determining a transmit timing difference (TTD) based on the first and second TA values;
determining the TTD exceeds a predefined threshold; and
invalidating the second TA value based on determining the TTD exceeds the predefined threshold.

46. The method of claim 45, further comprising:
starting or restarting a timer associated with the second cell based on obtaining the second TA value; and
stopping the timer based on determining the TTD exceeds the predefined threshold.

47. The method of claim 45, wherein the first cell is a source cell and the second cell is a target cell that is a layer 2 triggered mobility (LTM) cell.
